(19) United States
(12) Patent Application Publication
(10) Pub. No.: US 2024/0009690 A1
(43) Pub. Date: Jan. 11, 2024

(54) GARDENING SPRINKLER

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., Changhua (TW)

(21) Appl. No.: 17/858,881

(22) Filed: Jul. 6, 2022

(51) Int. Cl. B05B 3/02; B05B 3/04

(52) U.S. Cl. CPC B05B 3/021; B05B 3/0409

(57) ABSTRACT

A gardening sprinkler may include a main body, a sprinkler member, and a control base, and the main body has a sprinkler base and an upper cover which are adapted to fit together. The sprinkler base is a hollow tube and has an opening at one end thereof, the sprinkler member is positioned into the sprinkler base through the opening, and a water inlet member is connected to the sprinkler base through the opening. The sprinkler base has a concaved portion and a sprinkler surface, and the concaved portion is formed adjacent to the other end of the opening. The sprinkler surface comprises a row of first through holes which are arranged axially, and upper cover has a row of second through holes at positions corresponding to the first through holes.

### FIELD OF THE INVENTION

The present invention relates to a gardening sprinkler and more particularly to a gardening sprinkler with flexible sprinkling angles.

### BACKGROUND OF THE INVENTION

As disclosed in U.S. Pat. No. 7,607,590B2, generally, a conventional gardening sprinkler comprises a base frame, and a tube-shaped shell is connected to the frame, and a water driving unit is connected to the shell. The water driving unit has a water inlet and a nozzle strip, and the nozzle strip is configured to contact the shell. The nozzle strip comprises a plurality of nozzles, and a pivot plate is adapted to contact the shell and the nozzle strip. The pivot plate further has an adjusting tab and a plurality of grooves, and the nozzles are configured to respectively penetrate through the grooves. The adjusting tab is located at a longitudinal central position of the pivot plate, and the pivot plate is pivotally rotatably about the longitudinal direction of the shell. Furthermore, a plurality of notches are formed on the shell, and a wedge is formed on an underside of the pivot plate. The wedge and notches allow the user to adjust the position of pivot plate to one of several positions by actuating adjusting tab.

However, the conventional gardening sprinkler has following disadvantages: (i) the user needs to pull hard in order to drive the wedge one by one across the notch, which is laborious, and the operation is noise; and (ii) the adjusting tabis easy to be broken during operation. Therefore, there remains a need for a new and improved design for a gardening sprinkler to overcome the problems presented above.

### SUMMARY OF THE INVENTION

The present invention provides a gardening sprinkler comprising a main body, a sprinkler member, and a control base, and the main body has a sprinkler base and an upper cover which are adapted to fit together. The sprinkler base is a hollow tube and has an opening at one end thereof, the sprinkler member is positioned into the sprinkler base through the opening, and a water inlet member is connected to the sprinkler base through the opening. The sprinkler base has a concaved portion and a sprinkler surface, and the concaved portion is formed adjacent to the other end of the opening. The sprinkler surface comprises a row of first through holes which are arranged axially, and upper cover has a row of second through holes at positions corresponding to the first through holes. Each of the second through holes is an axial elongated hole, and the length of the second through holes is provided to be gradually enlarged from the center to both ends of the upper cover. The control base is positioned in the concaved portion, and the cover is coupled with the concaved portion to secure the control base therebetween. A first edge of the upper cover has a notch at the center portion thereof, and at least a protruding portion is formed on the inner surface of the upper cover. The protruding portion is located adjacent to the notch, and a row of locating slots are formed on the protruding portion.

The sprinkler member has a connecting strip which is adapted to connect to a plurality of sprinkler heads, and after the sprinkler member is positioned in the sprinkler base through the opening, each of the sprinkler heads is adapted to pass through the first through hole, the control base, and the second through hole, and out of the upper cover. The connecting strip is adapted to bear against the sprinkler surface of the sprinkler base. The top surface of the control base comprises a plurality of elongated adjusting holes which are arranged with radial inclination to both ends. The central portion of the control base comprises a neck portion at the edge thereof, and the neck portion is outwardly connected to a handle, and at least one end of the neck portion has an accommodating space. A spring is disposed on a locating bolt, and the locating bolt together with the spring is located into the accommodating space, and the spring is adapted to push the locating bolt outwardly. The control base is positioned in the concaved portion between the sprinkler base and the upper cover, and the handle is configured to penetrate out from the notch, and the sprinkler heads are adapted to penetrate out from the adjusting holes respectively. With the spring, the control base is pulled with less effort, and after pulling, the spring is configured to push the locating bolt into another locating slot, so as to keep the control base at the adjusted angle.

Comparing with conventional gardening sprinkler, the present invention is advantageous because: with the spring, the locating bolt is easily pressed into the accommodating space, and pops out and couples into another locating slot, which makes the gardening sprinkler operate smoothly, noise-reducing, longer service life, and labor-saving when adjusting the water outlet angle.

### BRIEF DESCRIPTION OF THE DRAWINGS

FIG. 1 is a three-dimensional assembly view of a gardening sprinkler of the present invention.

FIG. 2 is a three-dimensional exploded view of the gardening sprinkler of the present invention.

FIG. 3 is a plan view of a main body of the gardening sprinkler of the present invention without an upper cover.

FIG. 4 is a sectional assembly view of the gardening sprinkler of the present invention.

FIG. 5 is a sectional view of FIG. 4 along line A-A.

FIG. 6 is a schematic view of the gardening sprinkler of the present invention when sprinkling performing with full shape pattern.

FIG. 7 is a schematic view illustrating the gardening sprinkler of the present invention without the upper cover is pulled.

FIG. 8 is a sectional view illustrating a handle of the gardening sprinkler of the present invention is pulled.

FIG. 9 is a sectional view of FIG. 8 along line A-A.

FIG. 10 is a schematic view of the gardening sprinkler of the present invention when sprinkling performing with fan shape pattern.

FIG. 11 is another embodiment of the gardening sprinkler of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

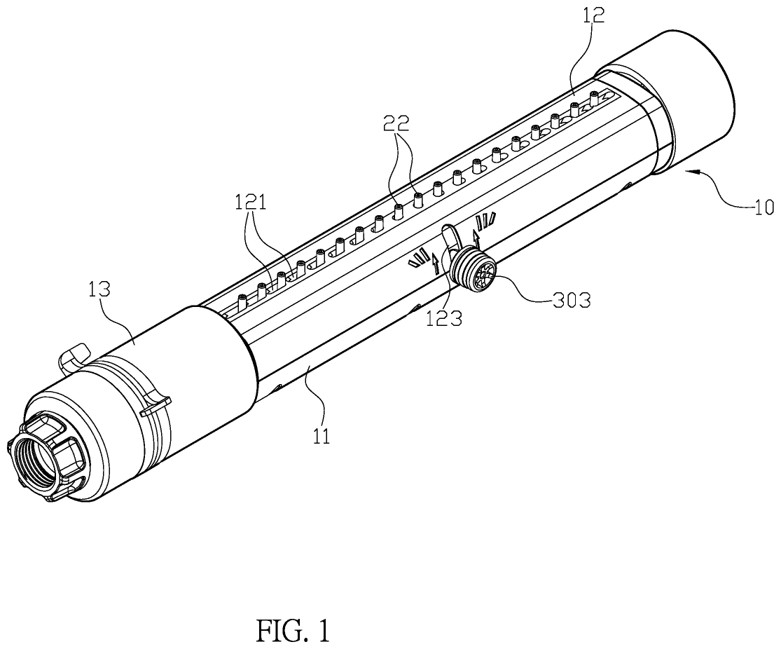

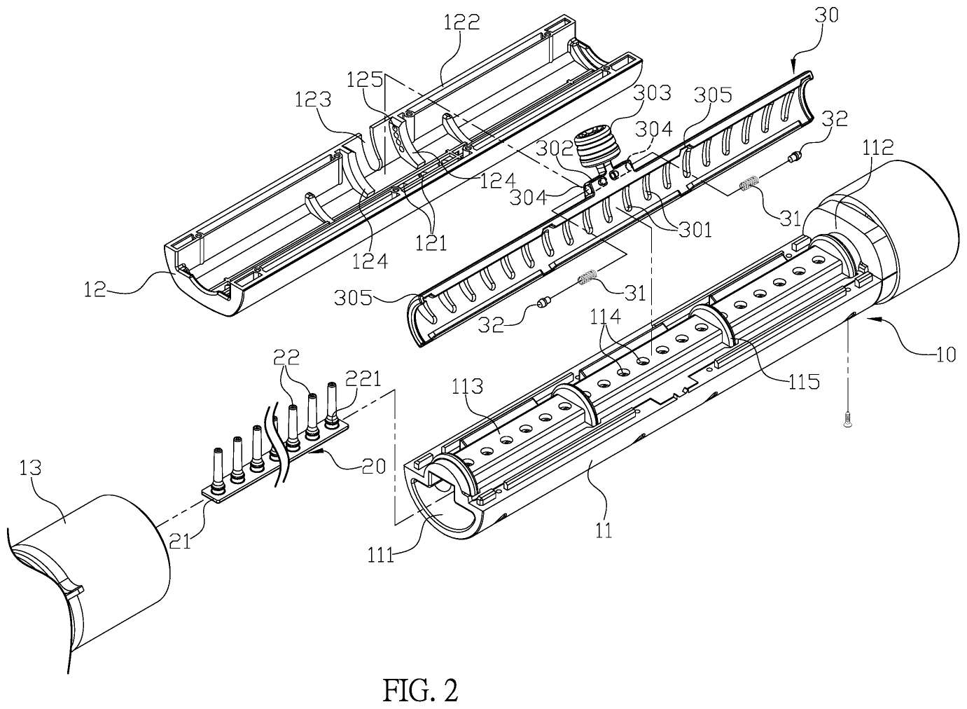

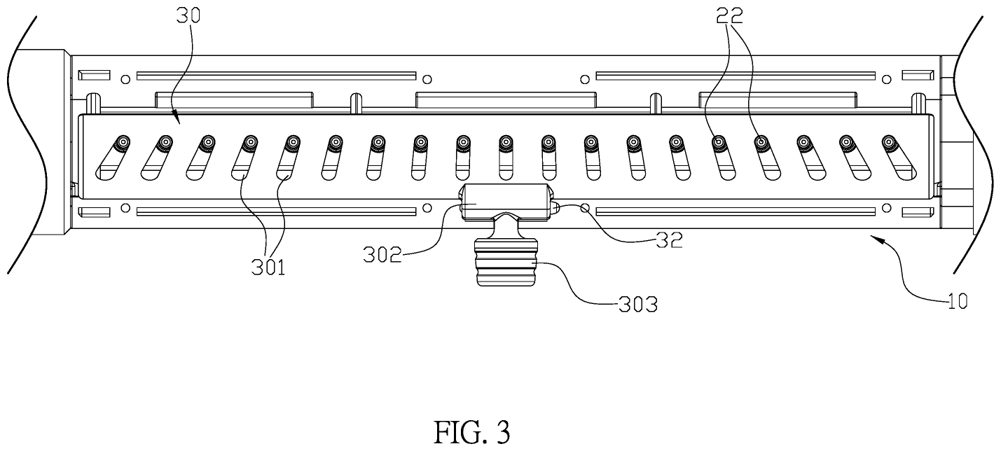

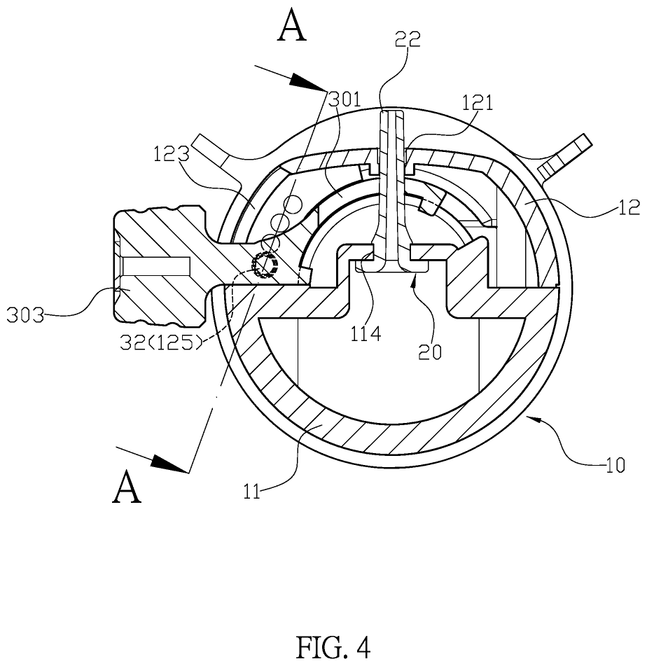

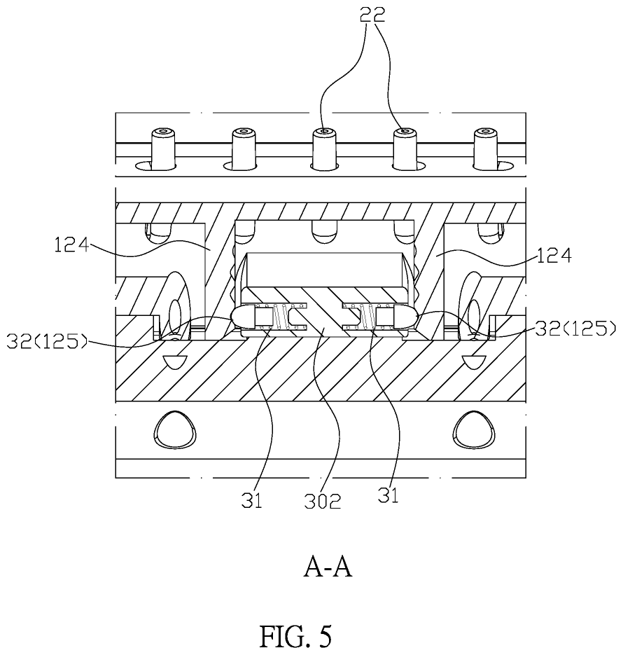

Referring to FIGS. 1 to 5, the present invention provides a gardening sprinkler comprising a main body (10), a sprinkler member (20), and a control base (30), and the main body (10) has a sprinkler base (11) and an upper cover (12) which are adapted to fit together. The sprinkler base (11) is a hollow tube and has an opening (111) at one end thereof, the sprinkler member (20) is positioned into the sprinkler base (11) through the opening (111), and a water inlet member (13) is connected to the sprinkler base (11) through the opening (111). The sprinkler base (11) has a concaved portion (112) and a sprinkler surface (113), and the concaved portion (112) is formed adjacent to the other end of the opening (111). The sprinkler surface (113) comprises a row of first through holes (114) which are arranged axially, and upper cover (12) has a row of second through holes (121) at positions corresponding to the first through holes (114). Each of the second through holes (121) is an axial elongated hole, and the length of the second through holes (121) is provided to be gradually enlarged from the center to both ends of the upper cover (12). Moreover, the control base (30) is positioned in the concaved portion (112), and the cover (12) is coupled with the concaved portion (112) to secure the control base (30) therebetween. A first edge (122) of the upper cover (12) has a notch (123) at the center portion thereof, and at least a protruding portion (124) is formed on the inner surface of the upper cover (12). The protruding portion (124) is located adjacent to the notch (123), and a row of locating slots (125) are formed on the protruding portion (124).

The sprinkler member (20) has a connecting strip (21) which is adapted to connect to a plurality of sprinkler heads (22), and after the sprinkler member (20) is positioned in the sprinkler base (11) through the opening (111), each of the sprinkler heads (22) is adapted to pass through the first through hole (114), the control base (30), and the second through hole (121), and out of the upper cover (12). The connecting strip (21) is adapted to bear against the sprinkler surface (113) of the sprinkler base (11). The top surface of the control base (30) comprises a plurality of elongated adjusting holes (301) which are arranged with radial inclination to both ends. The central portion of the control base (30) comprises a neck portion (302) at the edge thereof, and the neck portion (302) is outwardly connected to a handle (303), and at least one end of the neck portion (302) has an accommodating space (304). A spring (31) is disposed on a locating bolt (32), and the locating bolt (32) together with the spring (31) is located into the accommodating space (304), and the spring (31) is adapted to push the locating bolt (32) outwardly. The control base (30) is positioned in the concaved portion (112) between the sprinkler base (11) and the upper cover (12), and the handle (303) is configured to penetrate out from the notch (123), and the sprinkler heads (22) are adapted to penetrate out from the adjusting holes (301) respectively. With the spring (31), the control base (30) is pulled with less effort, and after pulling, the spring (31) is configured to push the locating bolt (32) into another locating slot (125), so as to keep the control base (30) at the adjusted angle.

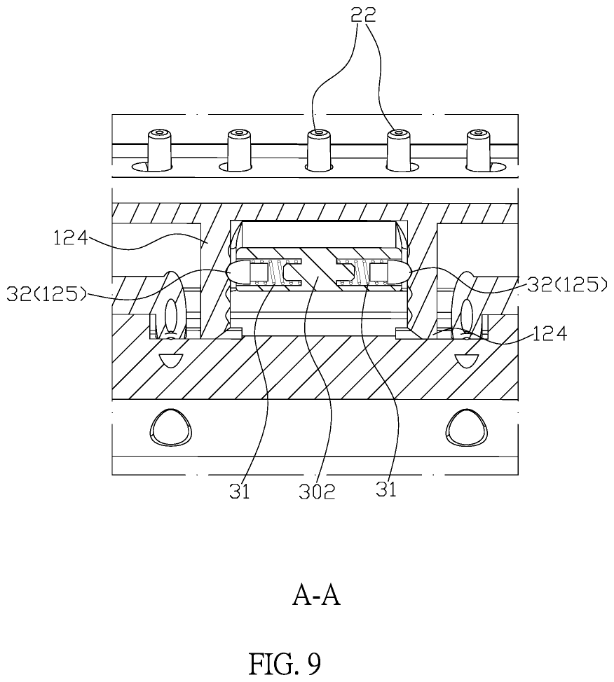

In one embodiment, the main body (10) is directly placed on the ground for use (as shown in FIGS. 1 to 10).

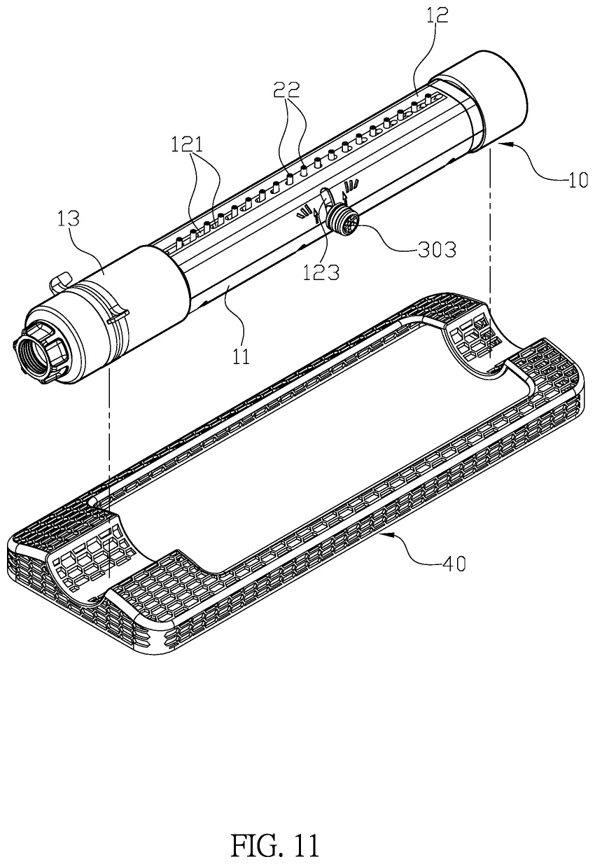

In another embodiment, the main body (10) is cooperated with a first base (40) for use (as shown in FIG. 11), and the main body (10) is configured to pivotally rotate on the first base (40) when sprinkling.

In still another embodiment, the sprinkler base (11) and the upper cover (12) are engaged in a locking way.

In a further embodiment, a plurality of arc ribs (115) are formed on the sprinkler surface (113) of the sprinkler base (11) while a plurality of locating recesses (305) are formed on the control base (30), and the arc ribs (115) are adapted to be coupled with the locating recesses (305) respectively, so that when pulled, the control base (30) is configured to rotate in the concaved portion only and not to have movement to both ends.

In still a further embodiment, each of two sides of the notch (123) has one protruding portions (124), and each of two ends of the neck portion (302) comprise one accommodating space (304), and each of the two accommodating spaces (304) has one spring (31) and one locating bolt (32) installed therein, so that the control base (30) is pressed on two sides, which makes the position of the control base (30) more secured.

In a preferred embodiment, each of the sprinkler heads (22) comprises an engaging groove (221) thereon, and the periphery of the first through hole (114) of the sprinkler base (11) is adapted to engage with the engaging groove (221) so that the sprinkler member (20) is secured on the sprinkler base (11).

In another preferred embodiment, the sprinkler heads (22) are elastic.

In an advantageous embodiment, the sprinkler heads (22) are made of rubber or similar materials.

In another advantageous embodiment, the control base (30) is an arc-shaped plate with an opening facing downward.

In still another advantageous embodiment, the neck portion (302) is a two-step shape, and small step portion is configured to connect to the handle (303) while the accommodating space (304), the spring (31), and the locating bolt (32) are arranged on the large step portion.

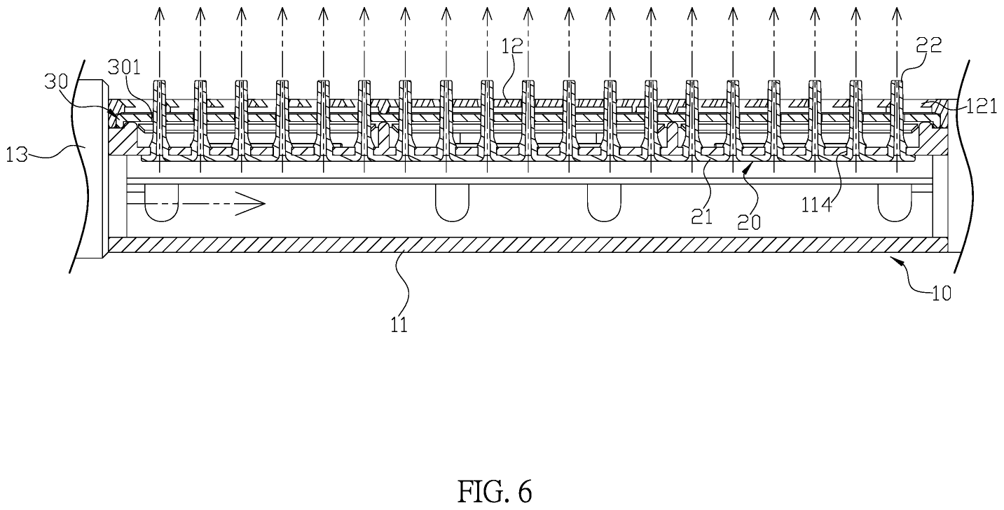

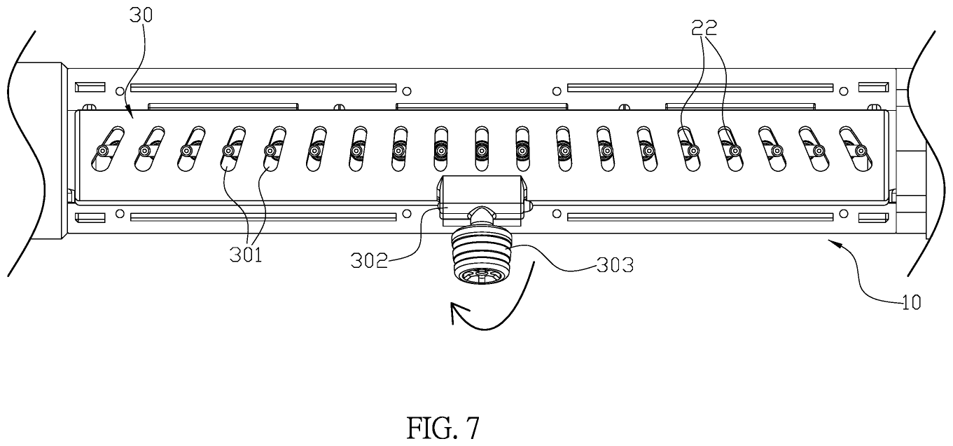

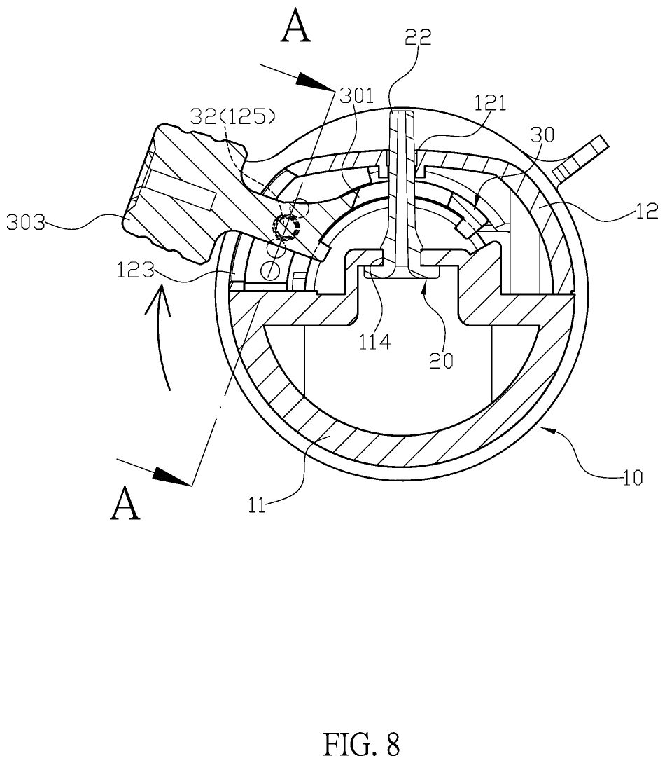

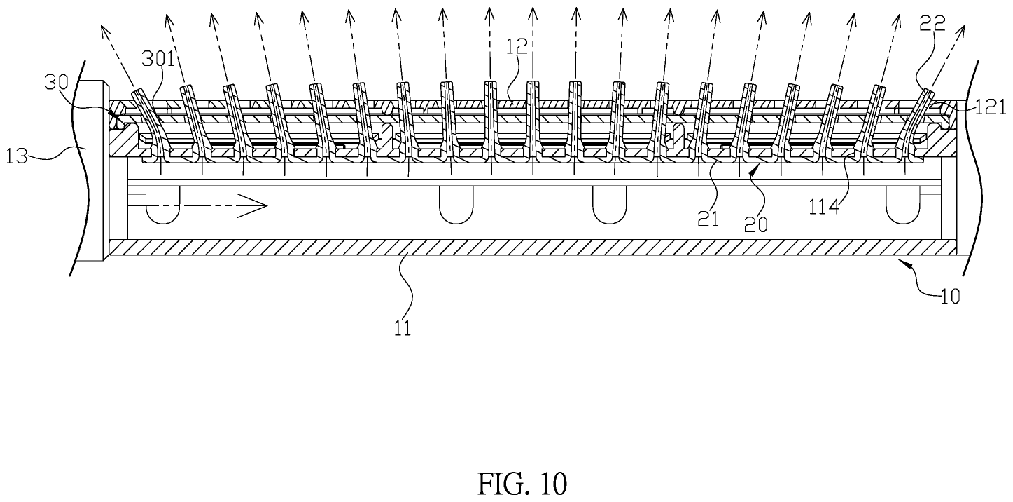

In actual application, through pulling the handle (303) (as shown in FIGS. 7 and 8), the control base (30) is driven to rotate toward different angles, and during the rotating process, the sprinkler heads (22) are adapted to bear against different portions of the adjusting holes (301) so as to drive the sprinkler heads (22) toward different angles, so that the sprinkler heads (22) are configured to perform different sprinkling patterns such as full shape (as shown in FIG. 6) and fan shape (as shown in FIG. 10). Also, with the spring (31), the locating bolt (32) is easily pressed into the accommodating space (304), and pops out and couples into another locating slot (125), which makes the gardening sprinkler operate smoothly, noise-reducing, longer service life, and labor-saving when adjusting the water outlet angle.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening sprinkler comprising a gardening sprinkler comprising a main body, a sprinkler member, and a control base;
wherein the main body has a sprinkler base and an upper cover which are adapted to fit together; the sprinkler base is a hollow tube and has an opening at one end thereof, the sprinkler member is positioned into the sprinkler base through the opening, and a water inlet member is connected to the sprinkler base through the opening; the sprinkler base has a concaved portion and a sprinkler surface, and the concaved portion is formed adjacent to the other end of the opening; the sprinkler surface comprises a row of first through holes which are arranged axially, and upper cover has a row of second through holes at positions corresponding to the first through holes; each of the second through holes is an axial elongated hole, and the length of the second through holes is provided to be gradually enlarged from the center to both ends of the upper cover; the control base is positioned in the concaved portion, and the cover is coupled with the concaved portion to secure the control base therebetween; a first edge of the upper cover has a notch at the center portion thereof, and at least a protruding portion is formed on the inner surface of the upper cover; the protruding portion is located adjacent to the notch, and a row of locating slots are formed on the protruding portion;
wherein the sprinkler member has a connecting strip which is adapted to connect to a plurality of sprinkler heads, and after the sprinkler member is positioned in the sprinkler base through the opening, each of the sprinkler heads is adapted to pass through the first through hole, the control base, and the second through hole, and out of the upper cover; the connecting strip is adapted to bear against the sprinkler surface of the sprinkler base; and
wherein the top surface of the control base comprises a plurality of elongated adjusting holes which are arranged with radial inclination to both ends; the central portion of the control base comprises a neck portion at the edge thereof, and the neck portion is outwardly connected to a handle, and at least one end of the neck portion has an accommodating space; a spring is disposed on a locating bolt, and the locating bolt together with the spring is located into the accommodating space, and the spring is adapted to push the locating bolt outwardly; the control base is positioned in the concaved portion between the sprinkler base and the upper cover, and the handle is configured to penetrate out from the notch, and the sprinkler heads are adapted to penetrate out from the adjusting holes respectively; with the spring, the control base is pulled with less effort, and after pulling, the spring is configured to push the locating bolt into another locating slot, so as to keep the control base at the adjusted angle.

2. The gardening sprinkler of claim 1, wherein the main body is directly placed on the ground for use.

3. The gardening sprinkler of claim 1, wherein the main body is cooperated with a first base for use, and the main body is configured to pivotally rotate on the first base when sprinkling.

4. The gardening sprinkler of claim 1, wherein the sprinkler base and the upper cover are engaged in a locking way.

5. The gardening sprinkler of claim 1, wherein a plurality of arc ribs are formed on the sprinkler surface of the sprinkler base while a plurality of locating recesses are formed on the control base, and the arc ribs are adapted to be coupled with the locating recesses respectively, so that when pulled, the control base is configured to rotate in the concaved portion only and not to have movement to both ends.

6. The gardening sprinkler of claim 1, wherein each of two sides of the notch has one protruding portions, and each of two ends of the neck portion comprise one accommodating space, and each of the two accommodating spaces has one spring and one locating bolt installed therein, so that the control base is pressed on two sides thereof, which makes the position of the control base secured.

7. The gardening sprinkler of claim 1, wherein each of the sprinkler heads comprises an engaging groove thereon, and the periphery of the first through hole of the sprinkler base is adapted to engage with the engaging groove so that the sprinkler member is secured on the sprinkler base.

8. The gardening sprinkler of claim 1, wherein the sprinkler heads are elastic.

9. The gardening sprinkler of claim 1, wherein the neck portion is a two-step shape, and small step portion is configured to connect to the handle while the accommodating space, the spring, and the locating bolt are arranged on the large step portion.
